(19) United States
(12) Patent Application Publication
(10) Pub. No.: US 2012/0228369 A1
(43) Pub. Date: Sep. 13, 2012

(54) OPENABLE PRODUCT PACKET FOR SLIDABLE ACCOMMODATION WITHIN A SLEEVE

(75) Inventor: Allen Aldridge, South Orange, NJ (US)

(73) Assignee: Kraft Foods Global Brands LLC, Northfield, IL (US)

(21) Appl. No.: 13/508,201

(22) PCT Filed: Nov. 9, 2010
(86) PCT No.: PCT/US10/55903

§ 371 Date: May 24, 2012

Related U.S. Application Data
(60) Provisional application No. 61/280,913, filed on Nov. 10, 2009.

(51) Int. Cl. B65D 5/38; B31B 49/02; B65D 5/42

(52) U.S. Cl. 229/125; 229/125.125; 229/125.015; 493/287

(57) ABSTRACT

A package assembly (10) provides for enclosing an array of aligned products (14) with a slidable sleeve (16) for removing the product. The package assembly includes a product packet (12) and a sleeve. The product packet encloses an array of aligned products and the packet conforms to the configuration of the product array. The sleeve has at least one open end slidably insertably and removably accommodating the product packet therein. The slidable removal of the packet from the sleeve opens the product packet.

### CROSS-REFERENCE TO RELATED APPLICATION

This application claims priority to U.S. Provisional Patent Application No. 61/280,913 filed on Nov. 10, 2009, the entire contents of which are incorporated by reference herein.

### FIELD OF THE INVENTION

The present invention relates generally to a package assembly for accommodating and dispensing consumable products arranged in an array. More particularly, the present invention relates to a product packet containing an array of consumable products and a sleeve slidably accommodating the product packet.

### BACKGROUND OF THE INVENTION

Certain consumable products, such as slabs of chewing gum, may be supported in a package housing which allows for dispensing of an individual product from the package while retaining the other products for future use. One type of package assembly which may be used to contain and dispense individually wrapped slabs of chewing gum includes a product packet, preferably made of foil, which encloses the products in the aligned array. The packet provides environmental protection to the products contained therein.

The product packet while conforming to the array of products, is typically housed in an outer housing of the package assembly. In order to remove the product, the packet must be opened to expose the products contained therein. In addition, as the products are removed from the packet on an individual basis, the packet housing must be constructed to support the product packet during continuous dispensing of individual products therefrom. Still further, the package housing should allow for enclosing of the remaining products contained within the packet.

It is desirable to have a package assembly which is both compact and easy to use and which opens the product packet upon use.

### SUMMARY

In one embodiment of the present invention, a package assembly is provided. The package assembly includes a product packet and a sleeve. The product packet provides for enclosing an array of aligned products wherein the packet conforms to the configuration of the product array. The product packet has an openable upper end for exposing the product array, and the packet includes a removable portion defining the open upper end. The sleeve has at least one open end slidably insertably and removably accommodating the product packet therein, wherein the slidable removal of the packet from the sleeve opens the product packet. The sleeve includes an adhesive surface engaged with the openable upper end of the packet for removing the removable portion of the packet upon the removal of the packet from the sleeve

In another embodiment of the present invention, a blank is provided for forming a sleeve package. The blank includes a pair of opposed major surfaces, an upper surface and a lower surface. The lower surface includes a top portion and a bottom portion which overlap during assembly. The pair of opposed major surfaces are separated by the upper surface; and the upper surface and the lower surface are smaller in length than each of the pair opposed major surfaces. The top portion extends from one of the pair of opposed major surfaces and the bottom portion extends from another of the pair of opposed major surfaces. The blank is rectangular in shape.

A further embodiment of the present invention is a method of forming the sleeve. The steps include cutting a blank from a sheet. The blank includes a pair of opposed major surfaces, an upper surface and a lower surface. The lower surface includes a top portion and a bottom portion which overlap during assembly. The pair of opposed major surfaces are separated by the upper surface; and the upper surface and the lower surface are smaller in length than each of the pair opposed major surfaces. The top portion extends from one of the pair of opposed major surfaces and the bottom portion extends from another of the pair of opposed major surfaces. The blank is rectangular in shape. The upper surface includes an adhesive strip on an inside surface of the upper surface. The next step includes folding the pair of opposed major surfaces along major fold lines, wherein the pair of opposed major surfaces are parallel, and perpendicular to the upper surface. A further step includes folding the bottom portion along a bottom fold line wherein the bottom portion is perpendicular to the opposed major surfaces and parallel to the upper surface. An additional step includes folding the top portion along a top fold line such that the top portion is parallel to the bottom portion. The next step includes adhering the top portion to the bottom portion defining the lower surface, wherein the pair of opposing major surfaces, upper surface, and the lower surfaces defines an interior cavity, the adhesive strip is located in the interior cavity.

### BRIEF DESCRIPTION OF THE DRAWINGS

FIG. 1 is a perspective showing of the package assembly of the present invention.

FIGS. 2 and 3 are perspective showings of one embodiment of the packaging assembly of the present invention.

FIG. 4 shows the flat blank used to form the sleeve of the packaging assembly of FIG. 1.

FIG. 5 shows the flat blank used to form the second embodiment of the sleeve of the packaging assembly of the present invention.

FIG. 6 shows the flat blank used to form the sleeve of a third embodiment of the packaging assembly of the present invention.

### DETAILED DESCRIPTION OF THE PREFERRED EMBODIMENTS

The present invention provides a package assembly in the form of a packet containing a plurality of consumable products wherein the packet is slidably received in a sleeve.

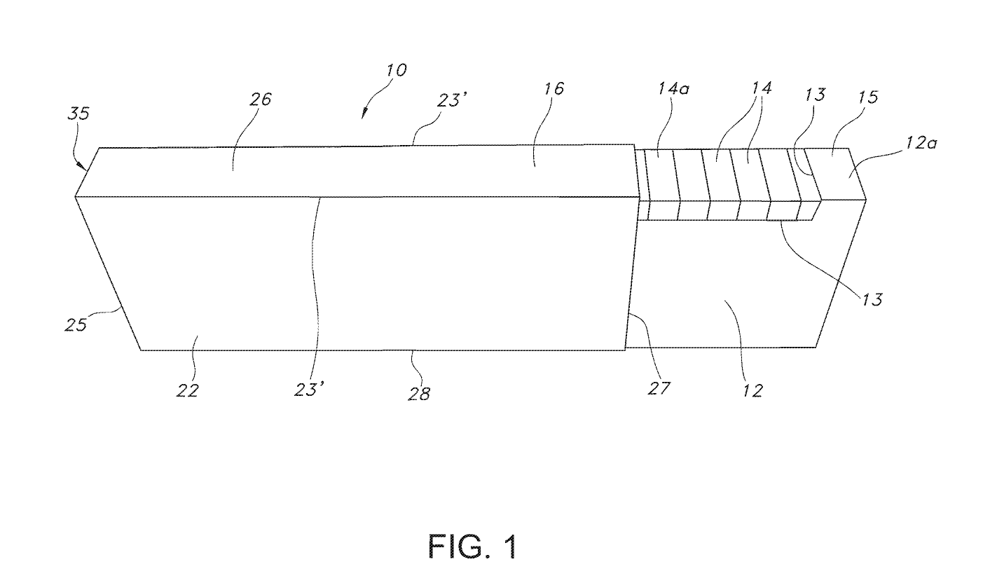

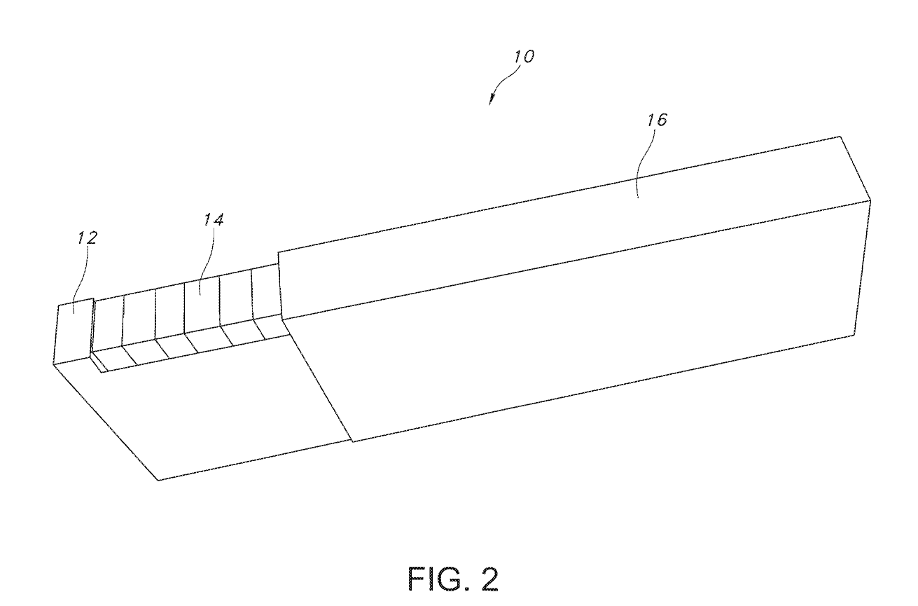

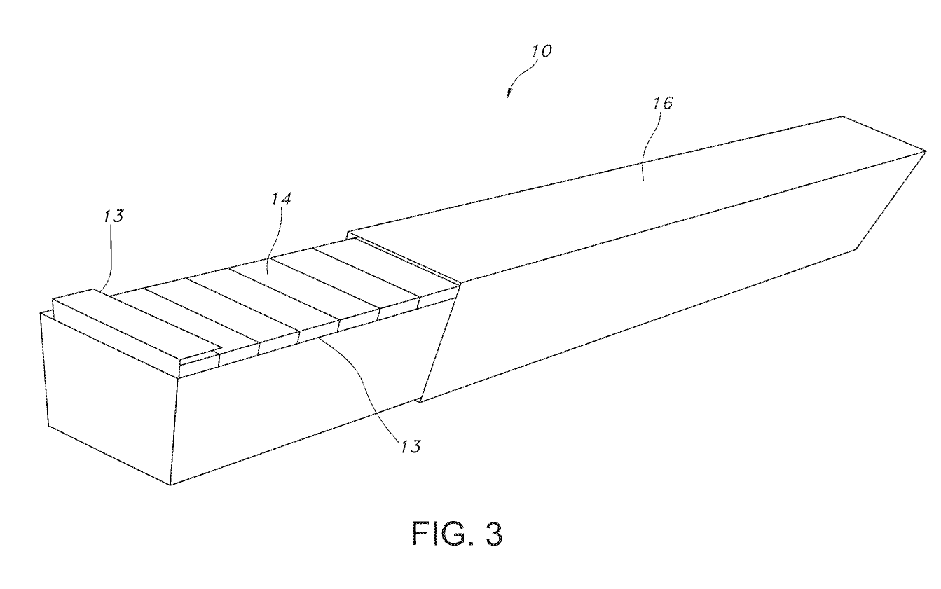

Referring to FIG. 1, one embodiment of the package assembly of the present invention is shown. The package assembly 10 includes a product packet 12 and a sleeve 16 for inserting and removing supports of the packet.

The packet 12 is constructed to accommodate a plurality of consumable products which are preferably flat gum slabs 14 arranged in a face-to-face array. The product packet 12 is formed from a rectangular sheet where the sheet may be formed from a single or multiply structure. The sheet preferably includes a paper surface forming the inside and an opposed foil surface forming the outside where the foil surface 15 provides environmental protection to the gum slabs 14 contained within the packet 12. In conventional fashion, the packet 12 is formed about the array of gum slabs 14 into a generally rectangular configuration. The packet could be a foil pack with a score line, a carton box with a foil overlay, or a combination of foil and paper carton. For example, the bottom portion can be a paper or carton material to provide the structure and the top portion may be foil connected to the bottom portion to allow for removal of the top portion.

In a preferred embodiment, the packet 12 entirely surrounds and encloses the array of gum slabs 14 contained therein. In order to dispense the product from the packet, an upper end 12a of packet 12 is removed so as to expose the upper end 14a of gum slabs 14. Thus as will be described in further detail hereinbelow, the present invention provides for removal of the upper end 12a of packet 12 upon removal of the packet from sleeve 16.

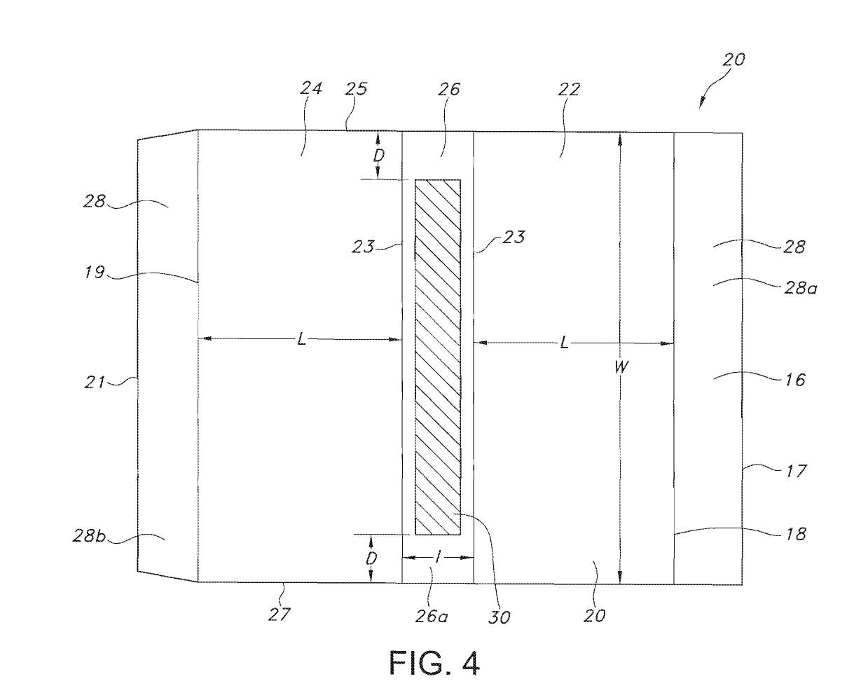

The packet 12 is designed for slidable accommodation within a sleeve 16. The sleeve 16 is formed from a generally rectangular paperboard blank 20, shown in FIG. 4. The sleeve 16 is constructed into a rectangular configuration which generally matches the rectangular configuration of packet 12. The sleeve 16 includes opposed major surfaces 22, 24, an upper surface 26, and a lower surface 28 formed by folded ends 28a,28b of the flat blank 20. The lower surface 28 has a top portion 28a and bottom portion 28b. Bottom portion 28b is defined as a planar surface extending between unattached ends 25,27 and foldable end 19 to unattached end 21. Top portion 28a is defined as a planar surface extending between unattached ends 25,27 and foldable end 18 to unattached end 17. Bottom portion 28b folds under top portion 28a such that bottom portion 28b is interior to sleeve 16 and opposes upper surface 26 once in folded configuration. The outer surface of bottom portion 28b (not shown) includes an adhesive to attach the outer surface of bottom portion 28b to the interior surface of top portion 28a. Major surface 22 is defined as a planar surface extending between unattached ends 25, 27 and foldable ends 18, 23. Opposing major surface 24 is defined as a planar surface extending between unattached ends 25, 27 and foldable ends 23, 19. Extending between major surfaces 22, 24 is upper surface 26. Upper surface 26 is defined as a planar surface extending between unattached ends 25, 27 and foldable ends 23, 23. The major surfaces 22, 24, upper surface 26, and top portion 28 have the same width W. Bottom portion 28b has the same width W at the fold line 19 but then decreases in width as ends 25,27 taper inwardly towards each other from fold line 19 to unattached end 21. The major surfaces 22, 24 have major length (L). The upper surface 26 and the top portion 28a have minor length (l). FIG. 4 shows major length (L) is larger than minor length (l). However, it is contemplated that major length (L) may be smaller than minor length (l). The length of the bottom portion 28b is about equal to or less than minor length (l). The opposed ends 25, 27 of sleeve 16 are preferably unattached or open to permit slidable removal and reinsertion of the packet 12 therethrough. During manufacturing of the package assembly 10, the sleeve 16 is preferably formed about the closed packet 12 with the gum slabs contained therein.

Generally, sleeve 10 is formed by placing the upper end 12a of closed packet 12 on top of upper surface 26, and bending at fold lines 23 such that major surfaces 22,24 are perpendicular to upper surface 26 and parallel opposed to each other. Major surfaces 22, 24 extend in either side of the closed packet. The next step includes bending at fold line 19 such that bottom portion 28b is perpendicular to major surface 24 and in parallel orientation with upper surface 26. Then bending fold line 18 such that top portion 28a covers a portion of bottom portion 28b, and top portion 28a is aligned with and parallel to bottom portion 28b. Top portion 28a is attached the respective flap, bottom portion 28b, by an adhesive to form lower surface 28. The closed packet 12 is surrounded by the sleeve 16 with two open ends represented by ends 25 and 27. The closed packet 12 extends within the interior cavity 35 of the sleeve 16.

Additionally, one technique for removing the upper end 12a of the packet 12 to expose the gum slabs 14 includes providing the inside surface 26a of the upper surface 26 of sleeve 16 with a rectangular adhesive strip or glue line 30. The glue line 30 is located within the interior cavity 35 of the sleeve 16. FIG. 4 shows glue line 30 inset from ends 25,27 on surface 26a a distance (D). When the sleeve is formed about the packet 12, a portion of the upper end 12a of the packet adheres to the rectangular glue line 30 such that when the packet 12 is slidably removed from the sleeve 16, the upper end 11a of the packet 12 remains adhered to the end of the glue line 30 and is thereby removed from the rest of the packet 12 exposing the gum slabs 14 contained therein.

In order to facilitate such removal, the packet 12 is scored or perforated at least partially about the upper end 12a so that it may be cleanly removed from the remainder of the packet 12. Once the packet 12 is removed from the sleeve 16, the desired number of gum slabs 14 may be dispensed and the packet containing the remaining gum slabs can be reinserted into the sleeve 16 through one of the open ends.

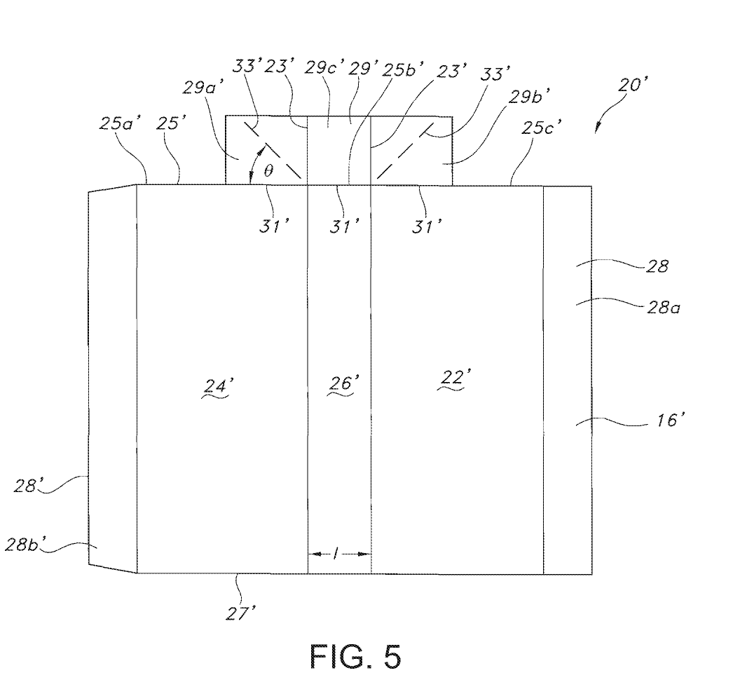

A further embodiment of the sleeve of the present invention is shown in FIG. 5 is substantially similar to the embodiment of the sleeve 16 as shown in FIG. 4. FIG. 5 shows sleeve 16′ including opposed major surfaces 22′, 24′, an upper surface 26′, and a lower surface 28′ formed by folded ends 28a′,28b′ of the flat blank 20′ and end flap 29′. In this embodiment, the sleeve 16′ has one of the open ends 25′ partially closed by an end flap 29′. This prevents the packet 12 from being removed in both directions, as the packet 12 can only be inserted and removed through the single, fully opened end 27′. The end flap 29′ only covers a portion of one of the ends 25′ so that a user can insert a finger through the partially open extent to push the packet out from the sleeve 16′ thereby facilitating dispensing of the product from the packet.

FIG. 5 shows end flap 29′ attached by material continuity to end 25′ by fold line 31′. End 25′ includes three sections 25a′, 25b′ and 25c′, and end 25′ includes unattached portions and attached portions at fold line 31′. The end flap 29′ extends partially from and is foldably connected to a portion of section 25a′. The end flap 29′ extends partially from and is foldably connected to a portion of section 25c′. Additionally, a portion of section 25a′ and 25c′ are not attached to end flap 29′ and remain unattached. These unattached portions of end 25′ will form the opening in the end of the sleeve 16′ for one to view and push the contents within outwardly from the sleeve toward end 27′. End flap 29′ extends along the entire minor length (l′) at fold line 31′ from surface 26′. End flap 29′ includes two foldable lines 33′which extend from the intersection of foldable line 31′ and 23′ to the outer unattached end of end flap 29′, as shown in FIG. 5. Foldable diagonal lines 33′ extend diagonally across each wing 29a′ and 29b′ at an angle θ to allow for the wings 29a′ and 29b′ to be folded inwardly and tucked behind central portion 29c′ once the sleeve 16′ is assembled. The angle θ may range from 20-60 degrees. It is also contemplated that end 29′ is unattached to main surfaces 22′, 24′, and end 29′ is only attached to surface 26′ at fold line 31′. In this embodiment, during assembly the wings 29a′, 29b′ would bend perpendicularly to central portion 29c′ and parallel to major surfaces 22′,24′. The wings 29a′,29b′ would be adjacently touching the surfaces of major surface 22′,24′ on the interior of the sleeve 16′.

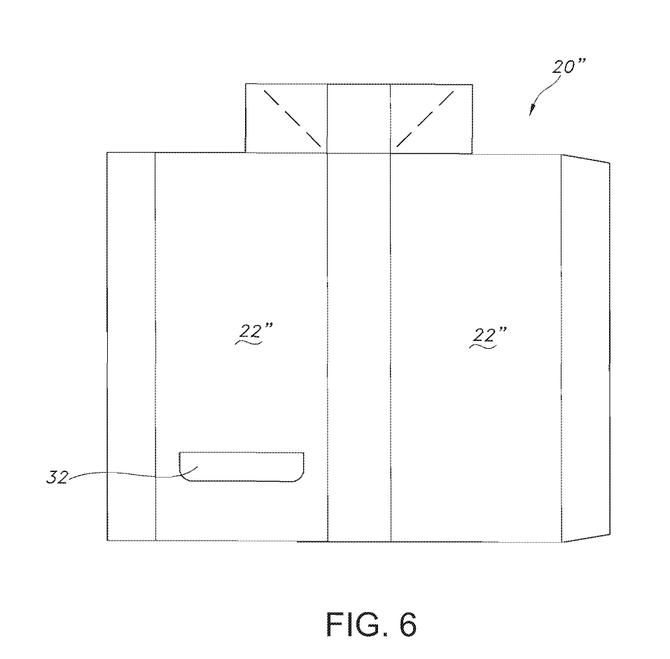

A still further embodiment of the sleeve of the present invention is shown in FIG. 6 which is substantially similar to the embodiment shown in FIG. 5. The embodiment shown in FIG. 6 is blank 20″. Blank 20″ includes a view window 32 which allows partial viewing of the contents contained within the sleeve. Such a viewing window 32 allows the consumer to determine how many gum slabs remain in the packet without having to fully remove the packet from the sleeve. The view window 32 may be made from transparent material that replaces the material of one of the major surfaces 22″, 24″. It is contemplated that the view window 32 may be includes in blanks 20, 20′ or 20″. It is also contemplated that the view window 32 may be included in any of the surfaces or multiple surfaces on a single blank.

Having described the preferred embodiments herein, it should now be appreciated that variations may be made thereto without departing from the contemplated scope of the invention. Accordingly, the preferred embodiments described herein are deemed illustrative rather than limiting, the true scope of the invention being set forth in the claims appended hereto.

What is claimed is:

1. A package assembly comprising:
a product packet for enclosing an array of aligned products wherein said packet conforms to the configuration of said product array, said product packet has an openable upper end for exposing said product array, said packet includes a removable portion defining said open upper end;
a sleeve having at least one open end slidably insertably and removably accommodating said product packet therein, wherein said slidable removal of said packet from said sleeve opens said product packet, said sleeve includes an adhesive surface engaged with said openable upper end of said packet for removing said removable portion of said packet upon said removal of said packet from said sleeve.

2. A package assembly of claim 1 wherein said sleeve includes at least one open end for said slidable insertion and removal of said packet therefrom.

3. A package assembly of claim 2 wherein said sleeve includes an opposite end which is at least partially closed.

4. A package assembly of claim 1 further including a viewing window for viewing the products therein.

5. A package assembly of claim 3 further including a viewing window for viewing the products therein.

6. A blank for forming a sleeve package comprising a pair of opposed major surfaces, an upper surface and a lower surface, said lower surface includes a top portion and a bottom portion which overlap during assembly; said pair opposed major surfaces are separated by said upper surface; said upper surface and said lower surface are smaller in length than each of said pair of opposed major surfaces; said top portion extends from one of said pair of opposed major surfaces and said bottom portion extends from another of said pair of opposed major surfaces, said blank is rectangular in shape.

7. The blank of claim 6 wherein said bottom portion includes a pair of tapered sides.

8. The blank of claim 6 wherein said upper surface includes an adhesive strip on an inside surface of said upper surface.

9. The blank of claim 8 wherein said adhesive strip is inset within said upper surface.

10. The blank of claim 6 further including an end flap foldably connected to said upper surface to provide a partially closed end of said sleeve.

11. The blank of claim 10 wherein said end flap a pair of foldable wings on either side of a central portion.

12. The blank of claim 11 wherein each of said pair of foldable wings includes a diagonal fold extending there across.

13. The blank of claim 12 wherein said central portion is foldably connected to said upper surface, and one of said foldable wings is foldably connected to a portion of one of said major surfaces, and another of said foldable wings is foldably connected to a portion of another of said major surfaces to allow said pair of wings to fold against said opposed major surfaces.

14. The blank of claim 13 wherein one of said major opposed surfaces includes a transparent viewing window therein.

15. Method of forming said sleeve; the steps comprising:
cutting a blank from a sheet, said blank comprises a pair of opposed major surfaces, an upper surface and a lower surface, said lower surface includes a top portion and a bottom portion which overlap during assembly; said pair opposed major surfaces are separated by said upper surface; said upper surface and said lower surface are smaller in length than each of said pair of opposed major surfaces; said top portion extends from one of said pair of opposed major surfaces and said bottom portion extends from another of said pair of opposed major surfaces, said blank is rectangular in shape; said upper surface includes an adhesive strip on an inside surface of said upper surface;
folding said pair of opposed major surfaces along major fold lines, wherein said pair of opposed major surfaces an parallel, and perpendicular to said upper surface;
folding said bottom portion along a bottom fold line wherein said bottom portion is perpendicular to said opposed major surfaces and parallel to said upper surface;
folding said top portion along a top fold line such that said top portion is parallel to said bottom portion; and
adhering said top portion to said bottom portion defining said lower surface, wherein said pair of opposing major surfaces, upper surface, and said lower surfaces defines an interior cavity, said adhesive strip is located within said interior cavity.

16. The method of claim 15 wherein said blank further includes an end flap foldably connected to said upper surface to provide partial closure of one end of said sleeve upon assembly and further including a step of folding said end flap along an end fold line wherein said end flap is perpendicular to said opposed major surfaces and said upper surface.

17. The method of claim 16 further including the step of forming a viewing window in one of said major surfaces for viewing contents within said sleeve.
